(19) United States
(12) Patent Application Publication
(10) Pub. No.: US 2018/0114279 A1
(43) Pub. Date: Apr. 26, 2018

(54) Automatic Newsletter Creation

(71) Applicant: Nuzzel, Inc., San Francisco, CA (US)

(72) Inventors: Jonathan Howard Abrams, San Francisco, CA (US); Kent Joseph Lindstrom, San Francisco, CA (US); Ross Ainsley MacKinnon, San Francisco, CA (US); Jose Montes de Oca, San Francisco, CA (US); Jari-lee Lactao Tolentino, South San Francisco, CA (US); Francisco Javier Vegas, Oakland, CA (US)

(21) Appl. No.: 15/793,712

(22) Filed: Oct. 25, 2017

Related U.S. Application Data
(60) Provisional application No. 62/413,284, filed on Oct. 26, 2016.

(51) Int. Cl. G06Q 50/00; G06Q 30/02; H04L 29/08; H04L 29/06

(52) U.S. Cl. CPC G06Q 50/01; G06Q 30/0277; H04L 65/602; H04L 67/306; H04L 67/12

(57) ABSTRACT

Articles are identified as potential candidates for inclusion in a newsletter generated for a user. The articles may be identified based on popularity or based on social activities (likes, comments, sharing, etc.) of social connections of the user. The user selects one or more articles for inclusion in the newsletter. The one or more articles may then be parsed and formatted for inclusion in the newsletter. Additional content such as comments and a promotional message may also be added to the newsletter. The newsletter may then be distributed to subscribers, such as by means of email, FACEBOOK MESSENGER or some other messaging system.

### RELATED APPLICATIONS

This application claims the benefit of U.S. Provisional Application Ser. No. 62/413,284, filed Oct. 26, 2016, which is hereby incorporated herein by reference in its entirety for all purposes.

### BACKGROUND

### Field of the Invention

This invention relates to automated generation of a newsletter.

### Background of the Invention

Social media has enabled users to connect with one another in meaningful ways. Users are able to express themselves and communicate with a wide audience. Many users are able to acquire many social media connections and become influencers in areas of politics, fashion, or some other area. Posts by a user will appear on in content feeds of the user's social media connections. Often, these posts will be lost among other items of content, advertisements, and sponsored content.

The system and methods disclosed herein provide an improved approach for influencers to provide content to one or more subscribers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a block diagram depicting an environment within which an example embodiment may be implemented.

FIG. 2 is a block diagram depicting an embodiment of a content management server.

FIG. 3 is a flow diagram depicting an embodiment of a method for initializing a new user to receive socially driven content.

FIG. 4 is a flow diagram depicting an embodiment of a method for generating a customized content feed for a user.

FIG. 5 is a flow diagram depicting an embodiment of a method for ranking and filtering multiple content items.

FIG. 6 is a flow diagram depicting an embodiment of a method for sending alerts to users.

FIG. 7 is a flow diagram depicting an embodiment of a method for generating a customized content feed for a user based on content items related to social updates of multiple social network users.

FIG. 8 is a block diagram depicting generation of a customized content feed.

FIG. 9 is a flow diagram depicting an embodiment of a method for generating a newsletter.

FIG. 10 is a flow diagram depicting another embodiment of a method for generating a newsletter.

FIG. 11 is a block diagram depicting the generation and distribution of a newsletter.

FIG. 12 is a block diagram depicting an example computing device.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

The articles “a” and “an” are used herein to refer to one or to more than one (i.e. to at least one) of the grammatical object of the article. By way of example, “a user” means one user or more than one user. Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware examples that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein aggregate, filter, and rank content from multiple social network sources. The resulting content feed is presented to a particular user. The ranking of content is at least partially based on interactions with content by other users who have social relationships with the particular user for which the content feed is created. The described systems periodically retrieve content that may be of interest to a user. When the user requests a current content feed, the system can provide the relevant content in substantially real time, thereby providing the user with highly relevant content in a short period of time.

As used herein, “content” (or “content item”) refers to any type of data in any format, such as news articles, documents, pictures, video recordings, audio recordings, event information, discount information, coupons, product information, shopping information, and the like. A “content feed” refers to a stream of multiple content items provided to one or more users. A “social relationship” includes any relationship between two or more users, such as friends, followers, fans, connections, circles, group members, and the like. These social relationships may be limited to relationships within one or more social networks. For example, two users may share as social relationship by both being associated with a common social network, but not share an actual “real world” relationship. In some situations, particular users may communicate exclusively through the social network, but not communicate in any other manner outside the social network. A “social update” (or “user update”) refers to user updates to one or more social network accounts, such as posts, tweets, statuses, status updates, and other updates. As used herein, “social activities” include any type of action or activity related to (e.g., responding to) a social update, such as liking a post, liking a status update, sharing a post, sharing a status update, retweeting a tweet, favoriting a tweet, favoriting a status update, and the like.

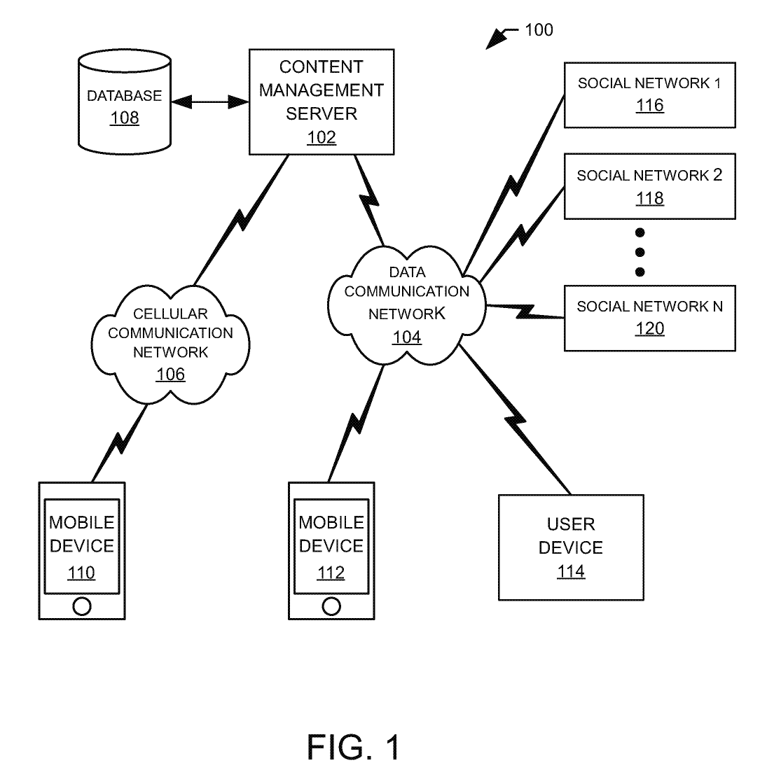

FIG. 1 is a block diagram depicting an environment 100 within which an example embodiment may be implemented. Environment 100 includes a content management server 102 coupled to a data communication network 104, such as the Internet, and a cellular communication network 106. Content management server 102 includes any type of computing device (and any number of computing devices) such as web servers, application servers, and the like. In some embodiments, content management server 102 is implemented using multiple virtual machines executing simultaneously. A particular content management server 102 interacts with multiple users and multiple social networks. Content management server 102 is also coupled to a database 108, which stores, for example, data received from any number of social networks.

Content management server 102 communicates with various systems, services, and devices through data communication network 104. Data communication network 104 may utilize any communication protocol and any type of communication medium. In some embodiments, data communication network 104 is a combination of two or more networks coupled to one another. Content management server 102 also communicates with various systems and devices, such as mobile devices, through cellular communication network 106, which may utilize any communication protocol and any type of communication medium. In some embodiments, cellular communication network 106 is a combination of two or more networks coupled to one another.

As shown in environment 100, a mobile device 110 communicates with content management server 102 through cellular communication network 106. Although a single mobile device 110 is shown in FIG. 1, particular embodiments may include any number of mobile devices (and non-mobile devices) communicating with content management server 102 through cellular communication network 106. A second mobile device 112 communicates with content management server 102 through data communication network 104. Although one mobile device 112 is shown communicating through data communication network 104, particular embodiments may include any number of mobile devices communicating with content management server 102 through data communication network 104. Mobile devices 110 and 112 include any type of device capable of communicating with content management server 102 through cellular communication network 106 or data communication network 104, such as a cellular phone, a smart phone, a tablet computer, a laptop computer, a desktop computer, a portable entertainment device, a portable gaming device, and the like.

Additionally, a user device 114 communicates with content management server 102 through data communication network 104. User device 114 includes any type of device capable of communicating with content management server 102 through data communication network 104, such as a tablet computer, a laptop computer, a desktop computer, a portable entertainment device, a portable gaming device, a game console, a set top box, and the like.

Multiple social networks 116, 118, and 120 are also coupled to data communication network 104. Social networks 116, 118, and 120 include any type of social network, such as Facebook, Twitter, LinkedIn, Google+, and the like. As discussed herein, content management server 102 interacts with social networks 116, 118, and 120 to identify, aggregate, and filter content that may be of interest to a particular user. The identified content is displayed to the user in a content feed via mobile device 110, 112 or user device 114. For example, the content feed can be displayed to the user through a web browser application running on mobile device 110, 112 or user device 114. Alternatively, the content feed is displayed to the user through another application running on mobile device 110, 112 or user device 114. In other embodiments, the content feed is provided to the user via an email message (e.g., email digest), text message or other communication system. In some implementations, the systems and methods described herein communicate one or more of the content items contained in the content feed to the user as an alert that is displayed, for example, on mobile device 110, 112 as a text message, application-generated message, alert notification, email alert or similar message.

The described systems and methods can create content feeds, email digests, and other collections of content items at any time based on the user's preferences. Content items are retrieved at periodic intervals so a content feed, email digest or other collection of content can be created at any time of the day with substantially real-time data. As discussed herein, new content items are identified and retrieved at regular intervals, such as every 15 minutes. Thus, when a user requests a content feed or email digest, they are presented with substantially real-time content with minimal delay. In some embodiments, the email digest includes the top five stories from the user's content feed during the preceding 24 hours. The email digest may also include one or more stories from the user's second degree social relationships. As discussed herein, a use may have a separate “second degree content feed” that includes content associated with, for example, “friends of friends.” Further, the email digest may include a top story from a content feed associated with one of the user's top social relationships.

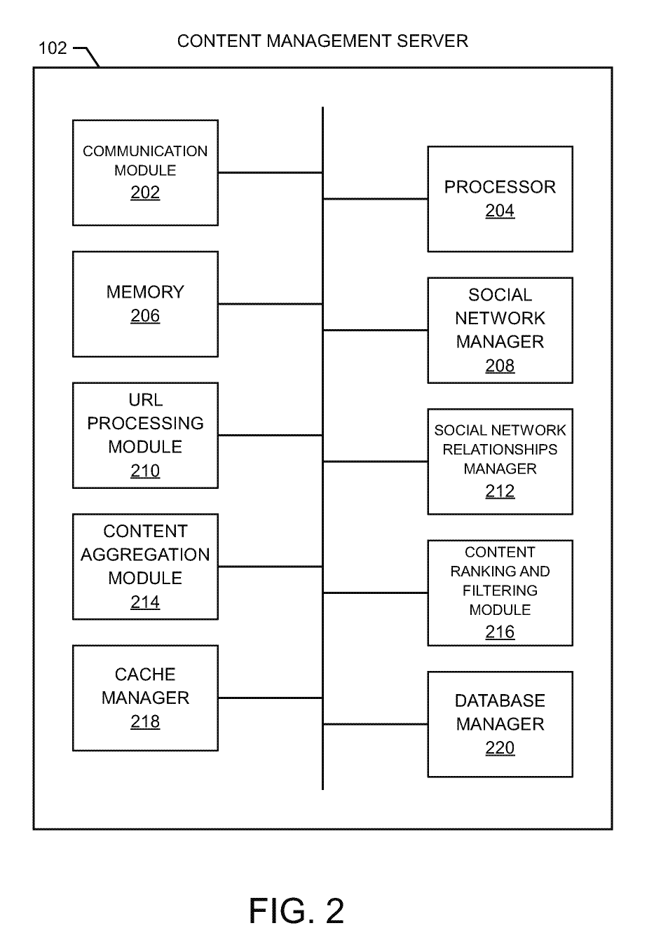

FIG. 2 is a block diagram depicting an embodiment of content management server 102. As discussed in greater detail below, content management server 102 performs various functions related to aggregating, filtering, and ranking of content, as well as presenting content feeds to multiple users. Content management server 102 includes a communication module 202, a processor 204, and a memory 206. Communication module 202 allows content management server 102 to communicate with other systems, such as communication networks, other servers, mobile devices 110 and 112, user device 114, social networks 116-120, and the like. Processor 204 executes various instructions to implement the functionality provided by content management server 102. Memory 206 stores these instructions as well as other data used by processor 204 and other modules contained in content management server 102.

Content management server 102 also includes a social network manager 208, which handles the receiving and processing of data from multiple social networks. In some embodiments, social network manager 208 also manages the storage of social network account information associated with multiple users. A URL (uniform resource locator) processing module 210 performs, for example, various tasks associated with finding the “destination content” associated with a particular URL. Some URLs are redirected to different URLs, which may then be redirected to another URL, and so on. As used herein, “destination content” or a “URL destination” refers to the final content (or URL associated with the final content) that is the “endpoint” of one or more URL redirects.

Content management server 102 also includes a social network relationships manager 212 that maintains information related to various social network relationships between multiple users. A content aggregation module 214 manages the aggregation of content from multiple social networks, as discussed herein. Content management server 102 also includes a content ranking and filtering module 216 that ranks the aggregated content and applies one or more filters to the aggregated content. A cache manager 218 manages cached data used by content management server 102, and a database manager 220 manages the storing and retrieval of data associated with database 108. In some embodiments, environment 100 includes both a cache and a database for storing data. In certain implementations the cache is located within content management server 102. Other embodiments of environment 100 include a database 108, but do not utilize a cache. Thus, cache manager 218 is provided in embodiments that include a cache for storing various information.

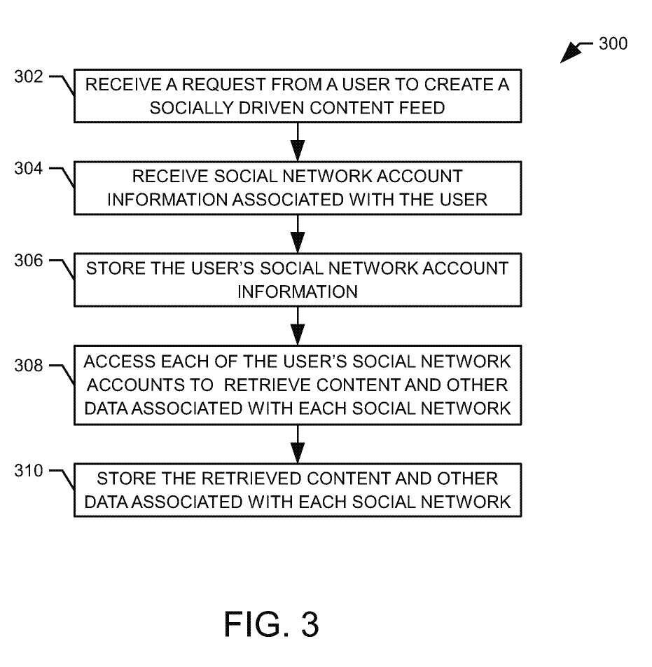

FIG. 3 is a flow diagram depicting an embodiment of a method 300 for initializing a new user to receive socially driven content. When a new user begins using the systems and methods described herein need to “catch up” on the user's current social media content by accessing the user's social media accounts and retrieving data from those accounts. Initially, method 300 receives a request from a user to create a socially driven content feed at 302. In response to the user request, method 300 receives social network account information associated with the user at 304. This account information may include a user identifier and an authentication token for each of the user's social network accounts. A particular user may have any number of social network accounts and any number of different user identifiers and authentication tokens for those accounts. In some implementations, the user identifier is a userid and the authentication token is an OAuth token, which is an open standard for authorization. In other implementations, the user identifier is a user name and the authentication token is a password.

Method 300 continues by storing the user's social network account information (e.g., user identifier and authentication token) for future reference at 306. Using the user's social network account information, the method accesses each of the user's social network accounts to retrieve content and other data associated with each social network at 308. In some embodiments, the content and other data is retrieved from multiple social network accounts simultaneously. To access the multiple social network accounts, some implementations use an API (application programming interface) to retrieve data directly from the social networks. Additional details are provided below regarding the process for retrieving content from the user's social network accounts. The retrieved content and other data associated with each social network is stored at 310 to provide fast access to the content in response to future requests from the user. After the new user has been initialized using method 300, the described systems and methods periodically update the content from the user's social network accounts. In some embodiments, the systems and methods update the content from the user's social network accounts every 15 minutes. These embodiments ensure that the system always has the latest content available to present to the user upon request in substantially real time.

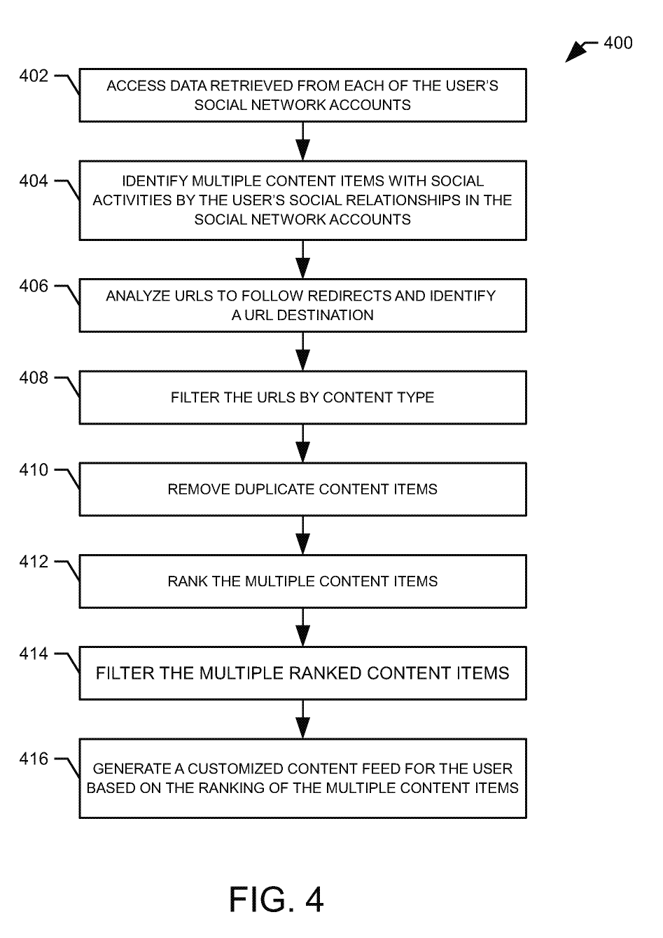

FIG. 4 is a flow diagram depicting an embodiment of a method 400 for generating a customized content feed for a user. Initially, method 400 accesses data retrieved from each of the user's social network accounts at 402. As mentioned above, content and other data is retrieved from the user's social network accounts as part of initializing a new account with the systems and methods described herein. Subsequent to the initialization, updated data is retrieved from the user's social network accounts periodically (e.g., every 15 minutes). Method 400 continues by identifying multiple content items with social activities (e.g., likes, shares, retweets or favorites) by the user's social relationships in social network accounts at 404. For example, method 400 identifies content items that have been seen and liked by several of the user's social relationships (e.g., friends, followers, fans or connections). These content items are likely to be of interest to the user based on the positive reaction to the content by the user's social relationships.

After identifying the multiple content items, method 400 analyzes URLs to follow one or more redirects to other URLs and, eventually, identify a URL destination at 406. This URL destination identifies a specific content item. Next, the method filters (or organizes) the URLs by content type at 408. Example content types include news stories, photos, videos, and the like. Method 400 continues by removing duplicate content items at 410. For example, multiple content items may include URLs that identify the same photo or the same news story. In this situation, the duplicate content items are removed such that each content item identifies unique content (as compared to the other content items). In other embodiments, duplicate content items are removed by examining URL patterns and HTML meta tags. Examples include using known patterns to convert mobile pages and print pages to the regular version of a news story URL, or using the Canonical Meta Tag inside a HTML document.

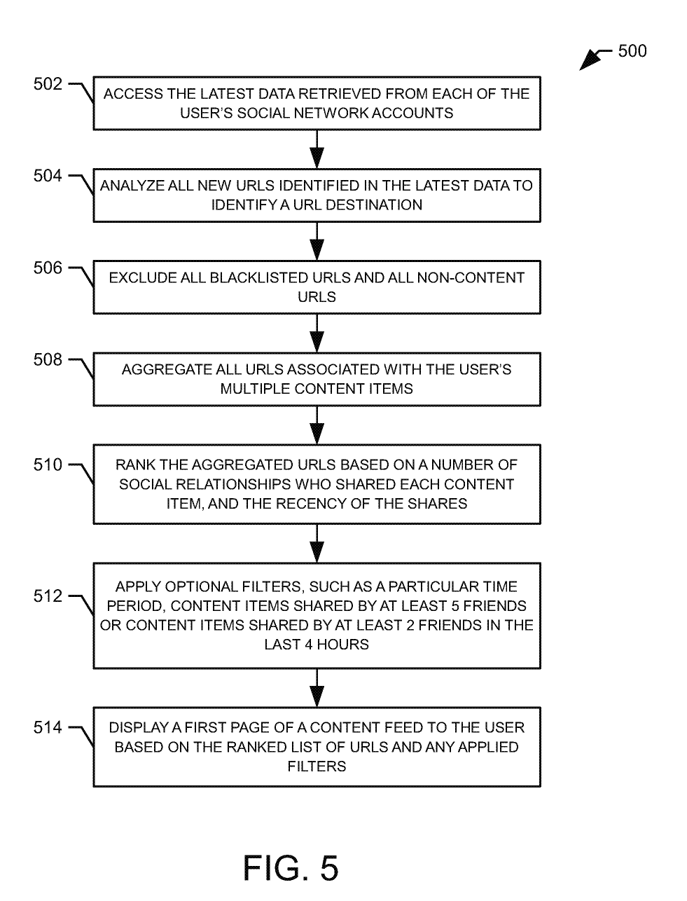

The multiple content items are ranked at 412 based on any number of factors, such as a frequency of social activities by the user's social relationships in the social network accounts, a quantity of social activities by the user's social relationships in the social network accounts, and a recency of the social activities (i.e., how recently the social activities have occurred). For example, if a first content item has been shared by five social relationships and a second content item has been shared by eight social relationships, the second content item is ranked above the first content item. The method may also filter the multiple ranked content items at 414 based on various filtering criteria. Additional details regarding the ranking and filtering of content items are discussed herein with respect to FIG. 5.

Method 400 continues by generating, at 416, a customized content feed for the user based on the ranking of the multiple content items. At least a portion of the customized content feed is then displayed to (or communicated to) the user. The customized content feed may include any number of content items. In some embodiments, the number of content items included in the content feed are limited to a top number of content items, such as the top 10 content items or the top 25 content items. In other embodiments, the number of top content items displayed varies depending on the size of the display screen. For example, a smaller screen may have space to display the top five content items, while a larger screen can display the top eight content items from the same content feed or email digest.

FIG. 5 is a flow diagram depicting an embodiment of a method 500 for ranking and filtering multiple content items. In the example of FIG. 5, content items are represented as URLs that identify a specific content item, such as a document, news item, photo, and the like. Similar techniques can be used with other symbols or identifiers that are associated with specific content items.

Initially, method 500 accesses the latest data retrieved from each of the user's social network accounts at 502. The method analyzes all new URLs identified in the latest data to identify a URL destination 504. As discussed above, the URL destination refers to the final content (or URL associated with the final content) that is the “endpoint” of one or more URL redirects. All blacklisted URLs and all non-content URLs are excluded at 506. When focusing on news stories, examples of non-content URLs include surveys, Foursquare checkins, Yelp reviews, Wikipedia pages, Flickr photos, Youtube videos, and the like. Blacklisted URLs include, for example, inappropriate content and spam content, such as fake news sites. Various entities or individuals can maintain lists of blacklisted content. In some embodiments, software algorithms may identify inappropriate content by analyzing the content to determine the number of words and paragraphs on a page. These software algorithms may also analyze text and photos/videos on a web site to identify spam, pornography or other inappropriate content.

Method 500 aggregates all URLs associated with the user's multiple content items at 508. The remaining URLs are then ranked, at 510, based on various factors, such as a number of social relationships who shared (or performed other social activities) each content item and/or the recency of those shares. Method 500 may also apply one or more optional filters at 512. Filters include, for example, particular time periods, minimum number of social activities to consider ranking a content item, and the like. In a particular implementation, a filter may require a social activity from at least three friends before the content item is considered for ranking. In another implementation, multiple filters may require a content item to be shared by at least two friends in the last four hours to be considered for ranking. Other factors that may be used to rank content include ranking content items based on the number of social activities from second degree relationships (e.g., friends of friends), ranking content items based on social activities from all users in a particular group, and ranking content based on social activities of all users of a particular social network. Additionally, ranking of content items may be further based on the publication (or web site) from which the content originates. Finally, method 500 displays, at 514, a first page of a content feed to the user based on the ranked list of URLs and any applied filters.

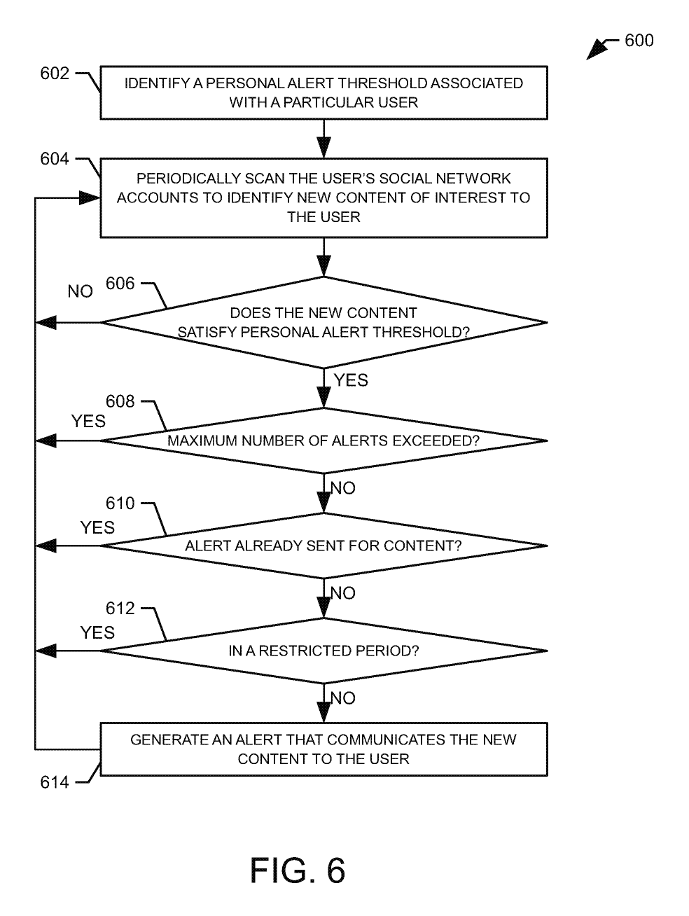

FIG. 6 is a flow diagram depicting an embodiment of a method 600 for sending alerts to users. Initially, method 600 identifies a personal alert threshold associated with a particular user at 602. In some embodiments, the personal alert threshold is defined by the user. In other embodiments, the systems and methods described herein can estimate an initial personal alert threshold for the user. The personal alert threshold represents the number of social activities a content item must receive before the content is considered for the user's content feed or included in an alert to the user. Each user can set their own personal alert threshold. For example, one user may set the personal alert threshold at five social activities while another user may set the threshold at seven social activities. The personal alert threshold may also require a specific number of social activities within a particular time period, such as three social activities within the last 12 hours. In some embodiments, different alert thresholds are used for different types of content. For example, defining a first alert threshold for news stories and a second alert threshold for photos. In alternate embodiments, alerts can be generated for a variety of activities, such as content items related to particular topics in another user's content feed.

Method 600 periodically scans the user's social network accounts to identify new content of interest to the user at 604. If one of the periodic scans identifies new content, the method 600 determines whether the new content satisfies the personal alert threshold associated with the user at 606. Initially, users may be assigned a default alert threshold. In some embodiments, the default alert threshold indicates that no alerts are sent during the first 24 hours after a user starts using the system. This time period is referred to as a “restricted period.” In alternate embodiments, the restricted period may be any duration. After the restriction period, the systems and methods analyze the user's content feed during a previous time period, such as the previous 24 hours. The content feed is sorted by the number of social relationships that share (or perform other social activities related to) each content item. A mathematical calculation is performed based on the number of shares of the top content items. In some embodiments, the default alert threshold is set to the number of shares of the highest (or second highest) content item. Alternate embodiments may apply a ratio, such as 80% of the highest number of shares, average the top few highest number of shares, and the like. In some embodiments, the systems and methods define a lowest allowed default alert threshold. An example of the lowest allowed default alert threshold is three. In this example, default alert thresholds of one or two would not be permitted. This prevents the user from receiving too many alerts.

If the new content does not satisfy the personal alert threshold, the method continues its periodic scans at 604. If the new content satisfies the personal alert threshold, the method next determines, at 608, whether a maximum number of alerts have been exceeded within a particular time period. For example, a user or a system may define a maximum number of alerts, such as eight alerts, that can be sent during a 24-hour period. This prevents the user from receiving too many alerts in a short period of time. If the maximum number of alerts has been exceeded at 608, the method continues its periodic scans at 604. If the maximum number of alerts has not been exceeded, method 600 determines whether an alert was already sent for the new content at 610. If an alert was already sent to the user, the method continues its periodic scans at 604.

If an alert was not previously sent to the user, method 600 determines whether the particular user is currently in a restricted period at 612. In some embodiments, alerts are restricted during the first 24 hours after a new user begins using the system. For example, the maximum number of alerts may be set to zero during the first 24 hours. This restriction allows the described systems and methods to wait until sufficient content items have been aggregated from the social networks to accurately calculate a default threshold for the new user. Additionally, this initial delay avoids being a nuisance to the new user by sending too many alerts or notifications shortly after starting to user the service. If the user is currently in a restricted period, the method continues its periodic scans at 604. However, if the user is not in a restricted period, method 600 generates an alert that communicates the new content item to the user at 614. The alert communicated to the user may be an email alert, mobile alert, text message, application-generated message, alert notification or other type of alert message. After communicating the alert to the user, the method continues scanning the user's social network accounts for new content.

In some embodiments, each user's alert threshold is recalculated periodically or after particular events. For example, the alert threshold may be recalculated after a user adds or removes a social network from their accounts. Additionally, the alert threshold may be recalculated if a user significantly increases or decreases the number of people they have social relationships with (e.g., significantly increase or decrease the number of people they are following). If the systems and methods described herein frequently identify more candidate alerts for a particular user than the current maximum number of alerts supported, the system may consider recalculating the user's alert threshold. In situations where the user has specified their own alert threshold, the systems and methods described herein may not change that alert threshold unless instructed by (or approved by) the user.

In some embodiments, when method 600 is determining whether to send an alert to a user, the method may also consider other factors, such as the rate at which a particular content item accumulates social activity from multiple social relationships. For example, if a particular content item reaches the user's alert threshold within 30 minutes, that content item is more likely to be sent to the user as an alert than another content item that takes several hours to reach the user's alert threshold.

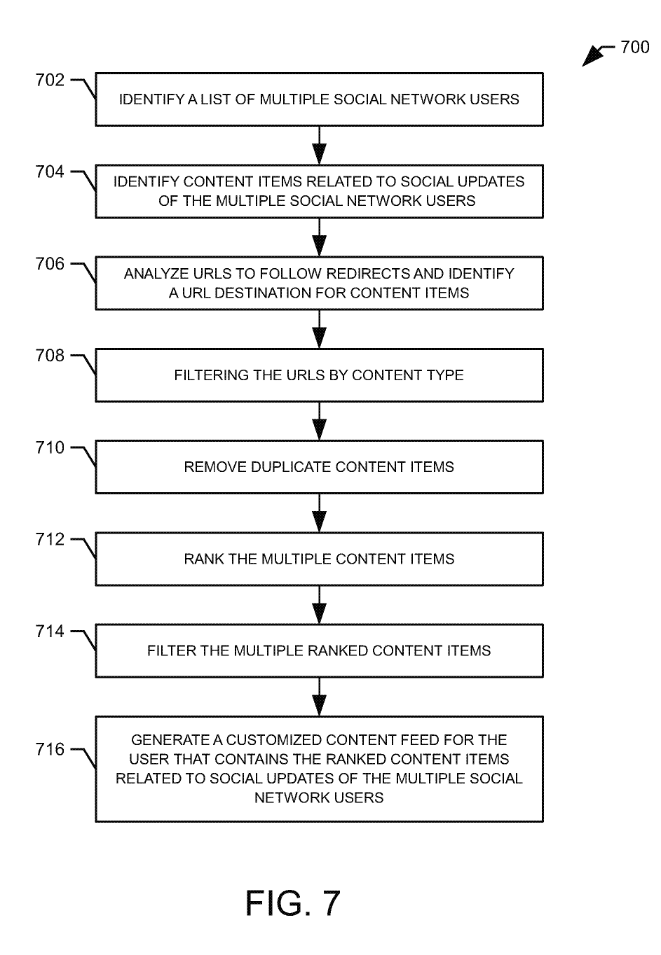

FIG. 7 is a flow diagram depicting an embodiment of a method 700 for generating a customized content feed for a user based on content items related to social updates of multiple social network users. The method described with respect to FIG. 7 is similar to the method discussed above regarding FIG. 4. However, method 700 generates a customized content feed based on, for example, a list of other social network users. In some embodiments, this list of social network users is focused on a particular topic, such as a list of users who are associated with particular industries (e.g., technology or automotive industries), particular hobbies (e.g., gardening or wine making), geographic areas (e.g., Boston or Southern California), and the like. In many situations, the content items related to a particular list of social network users are related to that list's industry, hobby or geographic area.

Initially, method 700 identifies a list of multiple social network users at 702. As mentioned above, this list of social network users may be associated with a particular topic or area of interest. In a particular embodiment, the list of social network users is a Twitter list. In other embodiments, the list of social network users can be a list of users from any social network, a group of users associated with one or more social networks, a list of other users created by the user who will receive the customized content feed, and the like. The method continues by identifying content items related to social updates of the multiple social network users at 704. For example, the identified content items are items that have been posted, tweeted, and included in status updates of the multiple social network users. In a particular embodiment that uses a Twitter list, the described systems and methods periodically request all new statuses tweeted by people on the Twitter list (e.g., using an API for the Twitter social network). Those new statuses are the content items that are filtered and ranked (as discussed below) to generate a customized content feed.

After identifying the content items at 704, the method analyzes URLs to follow redirects and identify a URL destination for content items at 706. As mentioned above, the URL destination identifies a specific content item. Next, method 700 filters (or organizes) the URLs by content type at 708. Example content types include news stories, photos, videos, and the like. The method continues by removing duplicate content items at 710. For example, multiple content items may include URLs that identify the same photo or the same news story. In this situation, the duplicate content items are removed such that each content item identifies unique content (as compared to the other content items).

The multiple content items are ranked at 712. Method 700 may also filter the multiple ranked content items at 714 based on various filtering criteria. Additional details regarding the ranking and filtering of content items are discussed herein with respect to FIG. 4 and FIG. 5. Method 700 continues by generating, at 716, a customized content feed for the user that contains the ranked content items related to social updates of the multiple social network users. The customized content feed may include any number of content items. As discussed above with respect to FIG. 4, the number of content items included in the content feed are limited to a top number of content items, such as the top 10 content items or the top 25 content items. In other embodiments, the number of top content items displayed varies depending on the size of the display screen. For example, a smaller screen may have space to display the top five content items, while a larger screen can display the top eight content items from the same content feed or email digest.

In some embodiments, the described systems and methods also generate a “second degree content feed,” which is also referred to as a “friends of friends feed.” This second degree content feed is created in a manner similar to the main content feed discussed herein, but instead looks at who user's social relationships follow. For example, the friends of the user's friends, people followed by the user's social relationships, fans of the user's social relationships, connections with the user's social relationships, and the like. So, instead of looking at social relationships of the particular user (i.e., first degree social relationships), the systems and methods identify who those social relationships follow (or have other social relationships with). The second degree content feed excludes people with which the particular user already has a social relationship. This second degree content feed creates an aggregated feed of content items that does not include content items included in the main content feed (i.e., the first degree content feed), to avoid being redundant with the main content feed.

As discussed herein, a “digest email” is sent to a user each day and identifies top content items from the user's main content feed (or second degree content feed). In some embodiments, a user can subscribe (via email) to any content feed created by the described systems and methods. A user does not need to be a “registered user” of the system and does not need to have created their own customized content feed to subscribe to another content feed created by another user or created by an entity providing the systems and methods described herein. After a user subscribes by email to a content feed, that user will receive the top content items from that content feed by email once a day. In other embodiments, the user (or the system) may define email delivery at different intervals, such as twice per day or once every 48 hours. In a particular implementation, the systems and methods attempt to determine the user's geographic location so that an email with the top content items can be sent to the user each morning (based on their local time zone). Alternatively, the user can define a particular time they want to receive the email messages. An “unsubscribe link” is provided in each email message that allows the user to unsubscribe from future emails. In some embodiments, an “edit delivery options” link may be provided in each email message that allows the user to change email delivery frequency and delivery time(s).

In particular embodiments, content management server 102 performs multiple tasks in parallel to support the substantially real-time operation of the described systems and methods. For example, content management server 102 may utilize multiple processors, servers, or virtual machines to analyze multiple URLs and follow their HTTP redirects simultaneously. This processing may be performed in parallel across multiple social networks for multiple different users. Additionally, the content management server 102 can perform various tasks asynchronously to ensure that substantially real-time content items are available to a user upon request. Thus, instead of waiting for a user request for content, the systems and methods described herein proactively retrieve and process relevant content from multiple sources, then store the content items for immediate access upon receipt of the user request.

In some embodiments, users who may not have their own content feed can look at the content feeds of other users. For example, a user may look at the content feed of a friend, a celebrity, or other user to see what content is contained in the other person's content feed. A particular user may be interested in the content items that are identified and ranked (as discussed herein) for one of their favorite celebrities or best friend. In some implementations, private content from the other user's social networks is filtered out of their publicly available content feed. In some embodiments, the described systems and methods these user content feeds are limited to public social networks to avoid disclosure of private content in the content feed. In alternate embodiments, private social networks may be supported, but only the public information from those social networks (or other social networks) are provided in the content feed.

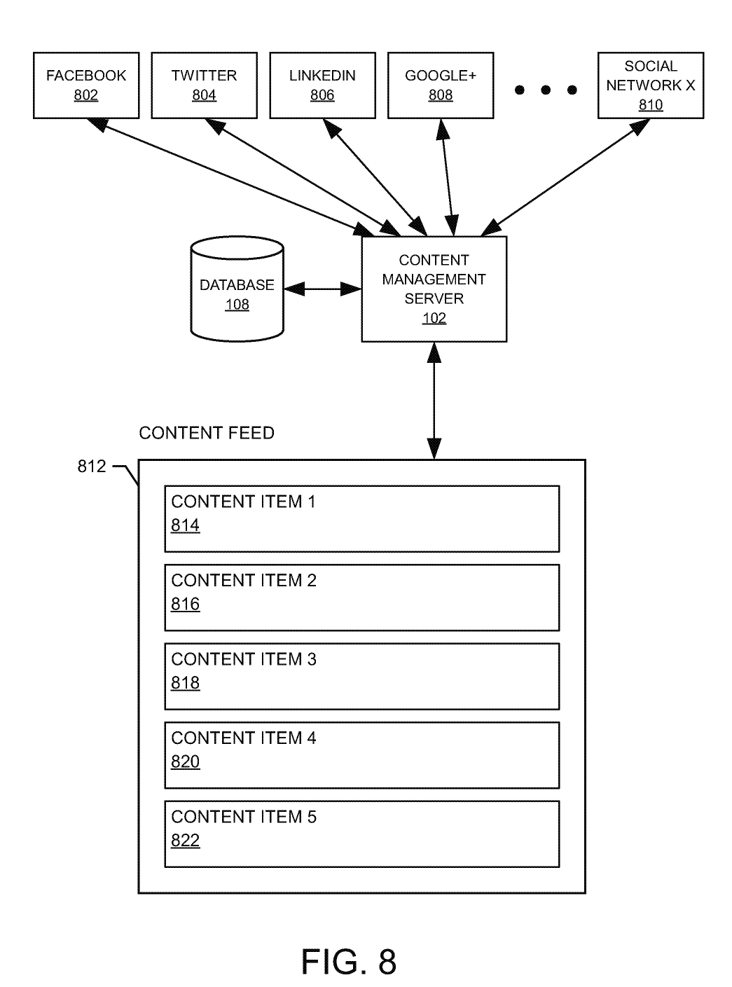

FIG. 8 is a block diagram depicting generation of a customized content feed. Content management server 102 receives content and other data from multiple social networks 802, 804, 806, 808, and 810. In the example of FIG. 8, social networks 802, 804, 806, and 808 represent Facebook, Twitter, LinkedIn, and Google+, respectively. In other embodiments, content management server 102 may receive content and other data from any number of social networks and other social sources. The received content is stored in database 108 to support fast retrieval of the data in response to a user request for a content feed. In some embodiments, content management server 102 receives content and other data from the multiple social networks 802-810 on behalf of multiple users that have accounts with one or more of the multiple social networks. When one of the users requests a content feed from content management system 102, the system identifies the highest ranked content items for the requesting user and communicates the content feed to the user. An example content feed 812 is shown in FIG. 8 including content items 814, 816, 818, 820, and 822. Content feed 812 is shown to contain five content items 814-822, but alternate content feeds may contain any number of content items. In some embodiments, content feed 812 is communicated to the user for display on a mobile device. In other embodiments, content feed 812 is communicated to the user via email, text or any other communication system.

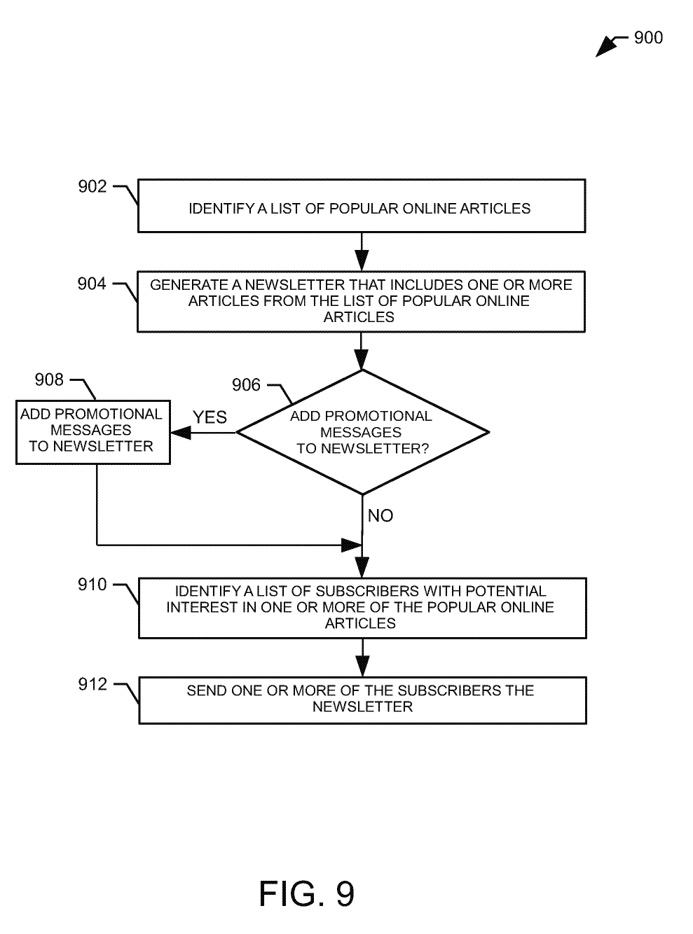

FIG. 9 is a flow diagram depicting an embodiment of a method 900 for generating a newsletter for a user (“the subject user”). As used herein, a newsletter is any type of document or data aggregation that includes one or more articles combined into a single document for the benefit of a reader (e.g., a human individual reading the document). The term “article” as used herein may refer to an article including text and possibly one or more images or other content items. The methods applied to articles herein may also be applied to images, video files, audio files, or combinations of such media files.

In some embodiments, the method 900 at 902 identifies a list of popular online articles. Step 902 may include identifying articles based on popularity, e.g. number of views, shares, likes, comments, etc. by the general public. In some embodiments, step 902 may include identifying articles only from among those referenced in social activities of social connections of the subject user. In particular, articles that are posted, viewed, favorited, liked, shared, or commented on by social connections of the user may be identified at step 902. In some embodiments, step 902 may include ranking of content items according to the methods of some or all of FIGS. 3 through 7. In particular, in the same manner that content items are selected for a user according to the methods of any of FIGS. 3 through 7, content items may be selected at step 902 as candidates for inclusion in a newsletter. Step 902 may also include generating separate lists of articles, one based on social activities of first degree connections and another based on social activities of the second degree connections of the user.

Note that step 902 may also include removing duplicate articles. Duplicate articles may be identified if multiple social connections have social activities with respect to the same article or the same user has social activities with respect to the same article using multiple platforms (such as bookmarklet or IOS SHARE SHEET). For example, URLs may be analyzed to avoid duplicates. In some instances, different URLS from the same publisher may refer to the same article web page. Accordingly, where this occurs, only one URL per article webpage will be included among the identified articles.

As is apparent, there are various means for identifying articles for potential inclusion in a newsletter. Lists identified according to these various means may be maintained separate or combined into a single list of articles available for selection by a user.

Next, at 904 the method generates a newsletter that includes one or more articles from the list of popular online articles. In some embodiments, the selection of articles from the list of online articles can be done by the owner of the newsletter or an authorized administrator. In other embodiments, a user (e.g., the owner of the newsletter or an authorized administrator) can manually select articles to include in the newsletter. In some embodiments, only selection by the user is required. Accordingly, the user is not required to format the selected articles or any other aspect of the newsletter in any way.

Generating 904 the newsletter may include parsing each article of the selection of articles and selecting one or more items of data from each article for formatting and inclusion in the newsletter. The newsletter may further include a link to the each article. Parsing may include searching content and formatting data of the article to identify such information as some or all of a title, a headline, an author, publication date, an image, an excerpt, an introductory paragraph, or other items of data. These items of data may then be formatted and added to the newsletter, e.g. a PDF (Portable Document Format) document, HTML (hypertext markup language) document, WORD document, or other type of document that implements the newsletter.

Multiple methods are used for obtaining the above-listed items of data from an article since many publishers do not follow proper industry standards for these items of data. In some embodiments multiple heuristics rules and methods are used, some of which may be publisher-specific. These methods may search for specific keywords or meta tags labeling a particular item of data.

For images, if meta tags for an image are not found in an article, a parsing method may include analyzing other images on the web page, such as all images on the web page for an article, and look at the dimensions of the images. Advertisements are preferably identified and ignored. For example, a largest image on the web page for an article may be selected as the representative image.

In some embodiments, parsing a document may include filtering out certain parts, such as portions that include links or likes for other articles. This is effective to remove incorrect dates and authors in these parts of the article that correspond to other articles. Accordingly, other tags or labels corresponding to a date or author are more likely to correspond to the correct date and author for the article.

To obtain the excerpt of the document, the document may be analyzed with a textual analyzer. The structure of the Document Object Model (DOM) for the article may also be analyzed to identify the text area of the document and exclude portions such as advertisements, site navigation elements, comments, and the like. A portion of the text areas identified may be selected as the excerpt, such as the first paragraph of these text areas.

The manually selected articles may be from the list of popular online articles or from any other source. At 906, the method checks to determine whether the owner of the newsletter wishes to add one or more promotional messages to the newsletter. If the owner of the newsletter does not wish to add one or more promotional messages to the newsletter, the method proceeds to step 910. If the owner of the newsletter wishes to add one or more promotional messages to the newsletter the method proceeds to step 908, where the one or more promotional messages are added to the newsletter. The promotional message may be a standard promotional message, e.g. a brief listing of biographical information from one of the user's social media profiles (e.g., TWITTER, FACEBOOK, etc.). The promotional message may be an advertisement of a sponsor or any other type of content the user wishes to add to the newsletter in addition to the selected articles.

The method then proceeds to 910, where the method identifies a list of subscribers with potential interest in one or more of the popular online articles. In some embodiments, subscribers may be the social connections of the user. In some embodiments, subscribers are manually added by the subject user, such as by bulk addition of email lists or other user identifiers.

Finally, at 912, the method sends the newsletter out to one or more of the subscribers via methods that include but are not limited to email, newsfeeds, FACEBOOK MESSENGER, and the like. In some embodiments, statistics that may include a newsletter's subscriber count and subscriber growth over a particular time period may be shared with a newsletter administrator (or other user or system) via web links, text messages, email or other communication mechanism.

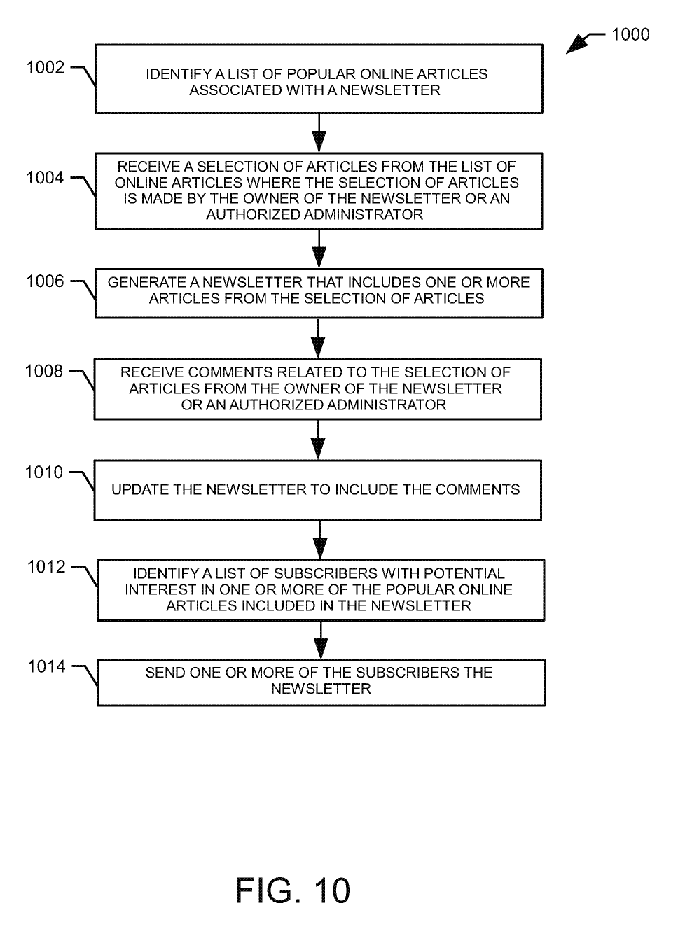

FIG. 10 is a flow diagram depicting another embodiment of a method 1000 for generating a newsletter. In some embodiments, method 1000 begins at 1002, where the method identifies a list of popular online articles associated with a newsletter, such as in the same manner as for step 902 of the method 900.

At 1004, the method receives a selection of articles from the list of online articles, where the selection of articles is made by the owner of the newsletter or by an authorized administrator. As for the method 900, selection 1004 may be manual step. Next, at 1006, the method generates a newsletter that includes one or more articles from the selection of articles. Generating 1006 the newsletter based on selected articles may be performed in the same manner as step 904 of the method 900.

At 1008, the method receives comments related to the selection of articles, where the comments are received from the owner of the newsletter or by an authorized administrator. At 1010, the newsletter is updated to include the comments, where a comment is associated with the corresponding article. Comments may include, for example, a summary of the article, the relevance of the article to a particular reader (or group of readers), a note directing the reader to a specific portion of the article, the commentator's opinion of the article and/or opposing views, and the like. At 1012, the method identifies a list of subscribers with potential interest in one or more of the popular online articles included in the newsletter. Finally, at 1014, the method sends the newsletter out to one or more of the subscribers via methods that include but are not limited to email, newsfeeds, and the like.

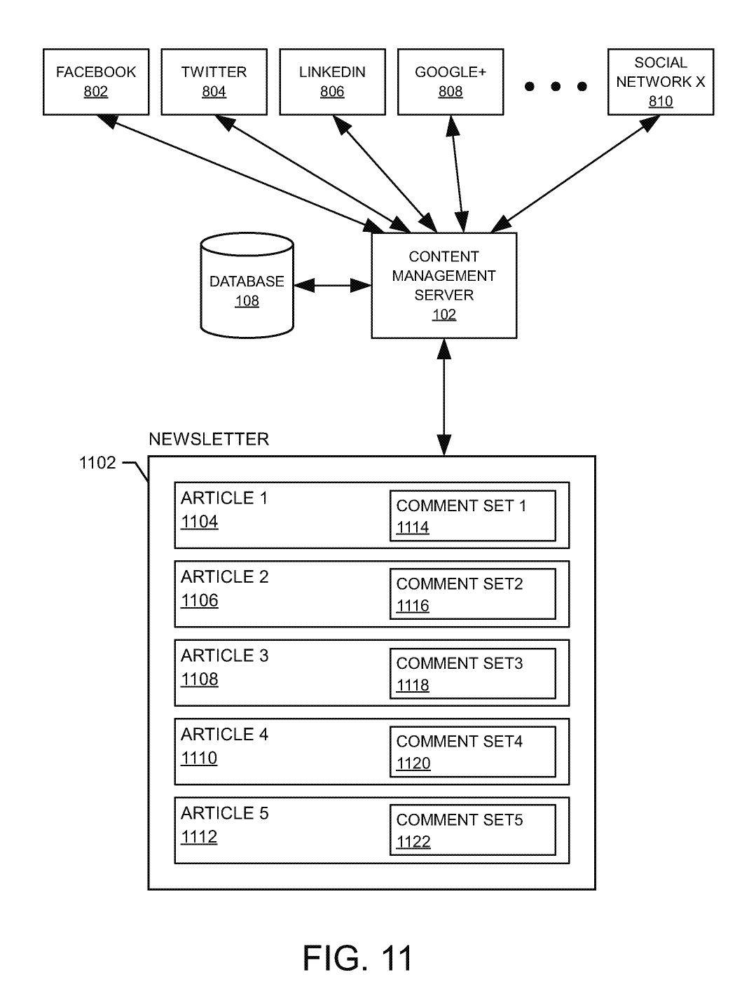

FIG. 11 is a block diagram depicting the generation and distribution of a newsletter. Content management server 102 receives content and other data from multiple social networks 802, 804, 806, 808, and 810, where the term “content” within the context of FIG. 11 refers to online articles that may be of interest to one or more subscribers to a newsletter. In the example of FIG. 11, social networks 802, 804, 806, and 808 represent Facebook, Twitter, LinkedIn, and Google+, respectively. In other embodiments, content management server 102 may receive content and other data from any number of social networks and other social sources. The received content is stored in database 108, and retrieved by the owner of the newsletter.

In some embodiments, the received content is assembled into a newsletter 1102, where the newsletter 1102 contains a number of articles such as article 1 1104, article 2 1106, article 3 1108, article 4 1110, and article 5 1112. In some embodiments, each article may be associated with comment sets provided by the owner of the newsletter or by an authorized administrator. For example, article 1 1104 may be associated with comment set 1 1114, article 2 1106 may be associated with comment set 2 1116, article 3 1108 may be associated with comment set 3 1118, article 4 1110 may be associated with comment set 4 1120, and article 5 1122 may be associated with comment set 5 1122. Upon request, newsletter 1102 may be sent out to one or more subscribers (not shown) via email, text or any other communication system.

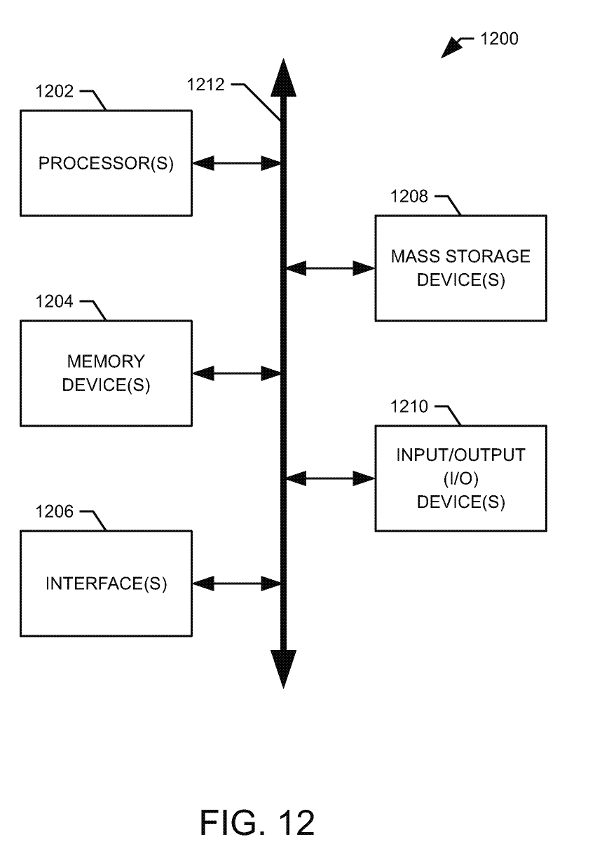

FIG. 12 is a block diagram depicting an example computing device 1200. Computing device 1200 may be used to perform various procedures, such as those discussed herein. Computing device 1200 can function as a server, a client or any other computing entity. Computing device 1200 can be any of a wide variety of computing devices, such as a desktop computer, a notebook computer, a server computer, a handheld computer, a tablet, and the like.

Computing device 1200 includes one or more processor(s) 1202, one or more memory device(s) 1204, one or more interface(s) 1206, one or more mass storage device(s) 1208, and one or more Input/Output (I/O) device(s) 1210, all of which are coupled to a bus 1212. Processor(s) 1202 include one or more processors or controllers that execute instructions stored in memory device(s) 1204 and/or mass storage device(s) 1208. Processor(s) 1202 may also include various types of computer-readable media, such as cache memory.

Memory device(s) 1204 include various computer-readable media, such as volatile memory (e.g., random access memory (RAM)) and/or nonvolatile memory (e.g., read-only memory (ROM)). Memory device(s) 904 may also include rewritable ROM, such as Flash memory.

Mass storage device(s) 1208 include various computer readable media, such as magnetic tapes, magnetic disks, optical disks, solid state memory (e.g., Flash memory), and so forth. Various drives may also be included in mass storage device(s) 1208 to enable reading from and/or writing to the various computer readable media. Mass storage device(s) 1208 include removable media and/or non-removable media.

I/O device(s) 1210 include various devices that allow data and/or other information to be input to or retrieved from computing device 1200. Example I/O device(s) 1210 include cursor control devices, keyboards, keypads, microphones, monitors or other display devices, speakers, printers, network interface cards, modems, lenses, CCDs or other image capture devices, and the like.

Interface(s) 1206 include various interfaces that allow computing device 1200 to interact with other systems, devices, or computing environments. Example interface(s) 1206 include any number of different network interfaces, such as interfaces to local area networks (LANs), wide area networks (WANs), wireless networks, and the Internet.

Bus 1212 allows processor(s) 1202, memory device(s) 1204, interface(s) 1206, mass storage device(s) 1208, and I/O device(s) 1210 to communicate with one another, as well as other devices or components coupled to bus 1212. Bus 1212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 900, and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
identifying, by a computer system, a list of online articles for association with a newsletter by a user;
receiving, by the computer system from a user, a selection of a plurality of selected articles from the list of online articles;
generating, by the computer system, a newsletter that includes the selected articles;
receiving, by the computer system, comments related to the selected articles;
updating, by the computer system, the newsletter according to the comments;
identifying, by the computer system, a plurality of subscribers for the newsletter; and
transmitting, by the computer system, the newsletter to the plurality of subscribers.

2. The method of claim 1, wherein identifying the list of online articles comprises identifying articles of the list according to popularity.

3. The method of claim 1, wherein identifying the list of online articles comprises identifying articles of the list according to social activities of social connections of the user in a social network.

4. The method of claim 3, wherein identifying the list of online articles comprises ranking each article of a plurality of articles referenced in a social media feed of the user according to a frequency of social activities of the social connections of the user with respect to the each article.

5. The method of claim 3, wherein identifying the list of online articles comprises ranking each article of a plurality of articles referenced in a social media feed of the user according to recency of social activities of the social connections of the user with respect to the each article.

6. The method of claim 3, wherein identifying the list of online articles comprises filters a plurality of articles referenced in a social media feed of the user according to a number of social activities of the social connections of the user with respect to each article of the plurality of articles within a particular time period.

7. The method of claim 1, wherein identifying the list of online articles comprises:
identifying a first list of articles according to social activities of social connections of the user in a social network with respect to a plurality of articles; and
identifying a second list of articles according to social activities of second degree social connections of the user in a social network with respect to the plurality of articles.

8. The method of claim 1, wherein generating, by the computer system, the newsletter that includes the selected articles, for each selected article:
parsing the each selected article;
selecting one or more portions of the each selected article; and
formatting the one or more portions for inclusion in the newsletter.

9. The method of claim 8, wherein the one or more portions include an author, a headline, an image, and a portion of text of the each selected article.

10. The method of claim 1, wherein transmitting, by the computer system, the newsletter to the plurality of subscribers comprises transmitting the letter using at least one of email and FACEBOOK MESSENGER.

11. An apparatus comprising one or more processing devices and one or more memory devices operably coupled to the one or more processing devices, the one or more memory devices storing executable code effective to cause the one or more processing devices to:
identify a list of online articles for association with a newsletter by a user;
receive a selection of a plurality of selected articles from the list of online articles;
generate a newsletter that includes the selected articles;
receive comments related to the selected articles;
update the newsletter according to the comments;
identify a plurality of subscribers for the newsletter; and
transmit the newsletter to the plurality of subscribers.

12. The apparatus of claim 1, wherein the executable code is further effective to cause the one or more processing devices to identify the list of online articles by identifying articles of the list according to popularity.

13. The apparatus of claim 11, wherein the executable code is further effective to cause the one or more processing devices to identify the list of online articles comprises identifying articles of the list according to social activities of social connections of the user in a social network.

14. The apparatus of claim 13, wherein the executable code is further effective to cause the one or more processing devices to identify the list of online articles by ranking each article of a plurality of articles referenced in a social media feed of the user according to a frequency of social activities of the social connections of the user with respect to the each article.

15. The apparatus of claim 13, wherein the executable code is further effective to cause the one or more processing devices to identify the list of online articles by ranking each article of a plurality of articles referenced in a social media feed of the user according to recency of social activities of the social connections of the user with respect to the each article.

16. The apparatus of claim 13, wherein the executable code is further effective to cause the one or more processing devices to identify the list of online articles by filters a plurality of articles referenced in a social media feed of the user according to a number of social activities of the social connections of the user with respect to each article of the plurality of articles within a particular time period.

17. The apparatus of claim 11, wherein the executable code is further effective to cause the one or more processing devices to identify the list of online articles by:
identifying a first list of articles according to social activities of social connections of the user in a social network with respect to a plurality of articles; and
identifying a second list of articles according to social activities of second degree social connections of the user in a social network with respect to the plurality of articles.

18. The apparatus of claim 11, wherein the executable code is further effective to cause the one or more processing devices to generate the newsletter that includes the selected articles by, for each selected article:
parsing the each selected article;
selecting one or more portions of the each selected article; and
formatting the one or more portions for inclusion in the newsletter.

19. The apparatus of claim 18, wherein the executable code is further effective to cause the one or more processing devices to identify the one or more portions to include an author, a headline, an image, and a portion of text of the each selected article.

20. The apparatus of claim 11, wherein the executable code is further effective to cause the one or more processing devices to transmit the newsletter to the plurality of subscribers by transmitting the letter using at least one of email and FACEBOOK MESSENGER.
